(19) United States
(12) Patent Application Publication
(10) Pub. No.: US 2010/0114408 A1
(43) Pub. Date: May 6, 2010

(54) MICRO AERIAL VEHICLE QUALITY OF SERVICE MANAGER

(75) Inventor: Emray R. Goossen, Albuquerque, NM (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/263,063

(22) Filed: Oct. 31, 2008

(51) Int. Cl. G01C 21/20; H04N 5/14

(52) U.S. Cl. 701/3; 348/576; 348/E05.062

(57) ABSTRACT

The present invention provides methods and systems for adjusting video quality outputted by an aerial vehicle to manage the data stream bandwidth to match the needs of each mission segment. A mission segment is monitored in order to determine a preferred video quality of service. A quality of service is set based on the monitored mission segment. The quality of service is selectively altered based on a change of at least one of a mission segment or an environmental condition.

### BACKGROUND OF THE INVENTION

An unmanned, aerial vehicle (UAV), sometimes called an “unmanned, air-reconnaissance vehicle,” is an unpiloted aircraft. UAVs can be remote controlled or fly autonomously based on pre-programmed flight plans or more complex dynamic automation systems. UAVs are currently used in a number of military roles, including reconnaissance operations.

The use of any UAV is beneficial only when information can be transmitted back to the operator in real time. As the skies above the battlefield become increasingly cluttered with UAVs, data links can be filled to capacity or overfilled, which results in congestion and poor performance. The flight characteristics of a hovering capable UAV; helicopter configuration, multi open blade, single ducted, or multi ducted has mission segments that require differing levels of quality in terms of image resolution and frame rates.

### SUMMARY OF THE INVENTION

The present invention provides methods and systems for adjusting video quality outputted by a hovering capable aerial vehicle. The purpose of each mission segment is defined so as to provide a preferred video quality of service. The quality of service changes from imaging needs for controlled flight above obstacles, to imaging needs for controlled flight through obstacles, and image quality for surveillance resolutions. During high speed cruise the image quality is of less interest than the image rate that supports control actions. During hover the image rate is of less importance than the image quality and resolution needed for surveillance. A quality of service is set based on the monitored mission segment and the available radio frequency bandwidth. The quality of service is selectively altered based on a change of at least one of a mission segment or an environmental condition.

### BRIEF DESCRIPTION OF THE DRAWINGS

Preferred and alternative embodiments of the present invention are described in detail below with reference to the following drawings:

FIG. 1 is a pictorial representation of a Quality of Service (QOS) manager; and

FIG. 2 illustrates a mission profile with differing segment objectives.

### DETAILED DESCRIPTION OF THE PREFERRED EMBODIMENT

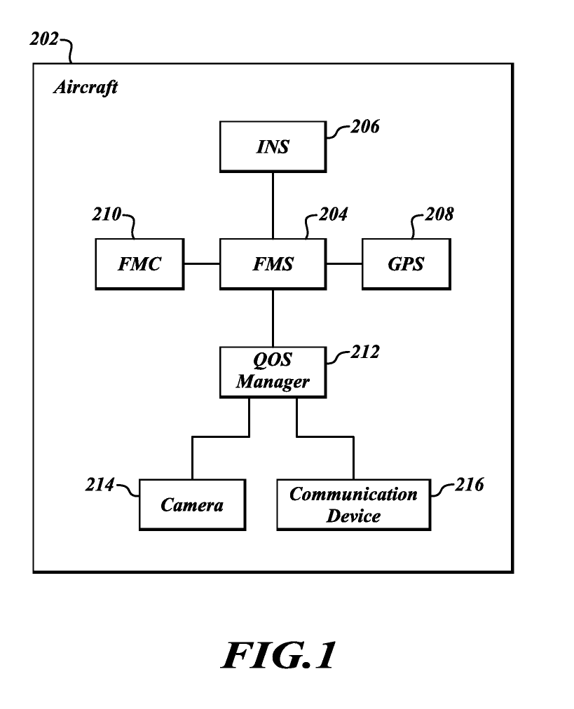

FIG. 1 illustrates a vehicle/aircraft 202, such as a hovering UAV, having an example Quality of Service (QOS) manager 212. The QOS manager 212 monitors mission segment (cruise, transition, hover, etc.) to set a predetermined quality of video to be down linked. Based on the mission segment of the 202, the QOS manager 212 sets a video quality (frame rate, resolution, etc.) in either real time by an operator or during mission planning to work with the communications link bandwidth limitations. The QOS manager 212 also evaluates the current conditions, such as turbulence, weather and lighting, to adjust for the best video quality. The QOS manager 212, in one embodiment, adjusts the output of a digital camera. By way of example when the aircraft 202 is operating in forward flight the frame rate may be set to high, such as 30 frames per second, but the image resolution may be set low to 320 px×240 px in order to reduce bandwidth required. The frame rate is set to high to allow for controllability of the flying the aircraft, but the level of detail can be lower because the operator need not see the airspace in high resolution to safely fly the aircraft 202. Conversely in a hover, when the aircraft 202 is in surveillance mode, the frame rate may be reduced to 5 frames per second, but the resolution increased to 1040 px×960 px. This shows the surveillance target clearly, but does not take up extra bandwidth because of the reduced frame rate.

The aircraft 202 includes a flight management system (FMS) 204. The FMS 204 generally includes or is in communication with an inertial navigation system (INS) 206 that communicates heading, velocities, and altitude, a global positioning system (GPS) 208 that communicates position information and a flight management computer (FMC) 210, that generates guidance information and coupled with the direction, altitude and current position provides flight commands to the FMS 204 in order to fly the aircraft 202. The FMS 204 is generally programmed for an entire mission prior to the aircraft 202 starting the mission. The FMS 204 contains information such as mission segments, waypoints, direction of travel and altitude. The FMC 210 is also in communication with a QOS manager 212 and sends information including current segment, based on direction of travel, altitude and current position, and conditions. The QOS manager 212 processes the segment information combined with the conditions to determine the frame rate and image size to provide the needed image quality for the mission segment. The QOS manager 212 also receives instructions from a ground controller using a communication device 216. The QOS manager 212 selectively activates a camera 214 on the aircraft 202. The aircraft 202 also includes the communication device 216 for transmission of images from the aircraft 202 to an operator. The communications device 216 may communicate with the ground station using digital, analog or any other communication means. In addition to the mission segment management of quality of service the QOS manager 212 may input environmental conditions such as time of day and imager direction relative to light sources, turbulence, and obscurants to enhance image quality,

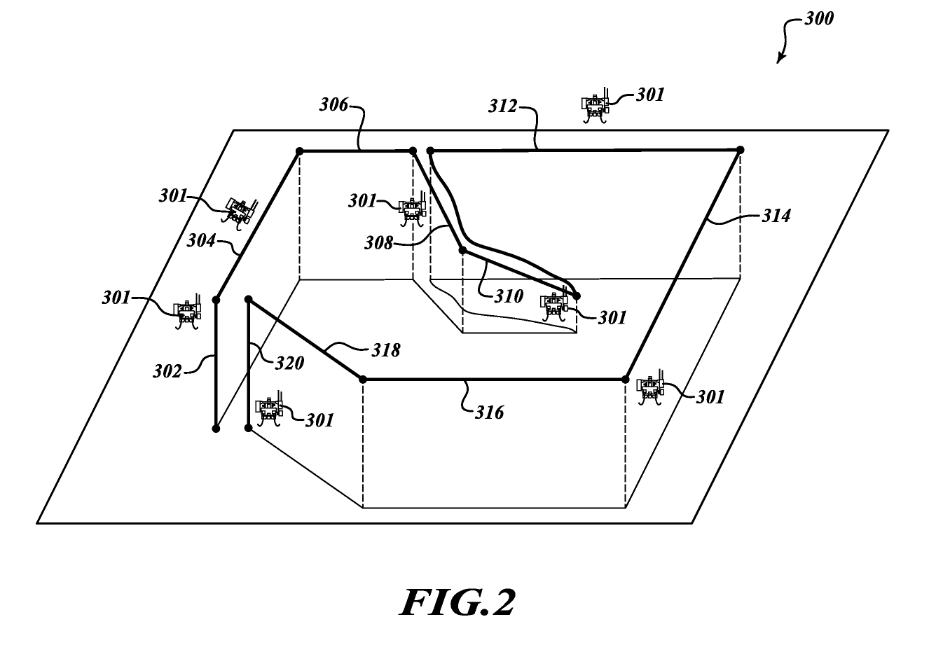

FIG. 2 illustrates a mission profile with differing segment objectives for which the QOS manager 212 controls image quality during an example programmed mission 300. In a first segment 302, a vehicle 301 is taking off and is in autonomous flight, meaning that it has been given flight instructions taking the vehicle 301 to a preprogrammed altitude. The first segment generally operates in a QOS state 1, which is used for normal flight and is generally a high frame rate and a low resolution. The second segment 304 and the third segment 306, shows the vehicle 301 traveling to a location, which again places the vehicle 301 in QOS state 1. In the fourth segment 308, the vehicle 301 is transitioning into an approach and surveillance mode. The fourth segment 308 is operating in QOS State 2, which has a medium frame rate and a medium resolution. The fifth segment 310 has the vehicle 301 in a hover and stare phase. The fifth segment 310 is operating with a lower frame rate and a higher resolution in order to capture the detail of what is happening below. The fifth segment 310 is operating in QOS state 3. The sixth segment 312 shows the vehicle 301 in slow flight surveillance, requiring a frame rate for flying the vehicle 301 but also uses a medium resolution trying to locate a target. In the sixth segment 312 the vehicle 301 is operating in QOS State 2. In the seventh 314, eighth 316 and ninth 318 segment's the vehicle 301 is flying back to the operators and is operating in QOS State 1. In alternate embodiments there exist additional alternate QOS States.

In another embodiment, the QOS manager 212 adjust one or more controllable settings of the camera 214. For example, an iris setting is adjusted. The iris setting determines the amount of light entering the camera 214, just like the iris of an eye. Other settings that can be changed on the camera 214 include shutter, aperture, backlight, shutter speed or any other setting that would increase or decrease the size in the recorded information, thereby allowing for more or less resolution.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for adjusting video quality of an aerial vehicle, the method comprising:
monitoring a mission segment in order to determine a preferred video quality of service;
setting a quality of service based on the monitored mission segment; and
selectively altering the quality of service based on a change of at least one of a mission segment or an environmental condition.

2. The method of claim 1, wherein setting quality of service further comprises setting a frame rate.

3. The method of claim 1, wherein setting quality of service further comprises setting a video resolution.

4. The method of claim 1, wherein setting quality of service comprises setting imager controls, the imager controls comprises two or more of iris, shutter, aperture, backlight, or shutter speed.

5. The method of claim 1, wherein the mission segment further comprises forward flight.

6. The method of claim 1, wherein the mission segment further comprises a hover and stare.

7. The method of claim 1, wherein the mission segment further comprises area surveillance.

8. The method of claim 1, wherein the environmental condition further comprises a weather condition.

9. The method of claim 1, wherein the environmental condition further comprises a light condition.

10. The method of claim 1, wherein the environmental condition further comprises a turbulence condition.

11. An aerial vehicle comprising:
a camera; and
a flight management computer located on the micro-aerial vehicle and configured to determine a mission segment of the micro-aerial vehicle using data from a global positioning system and an inertial navigation system and configured to set a quality of service for the camera based on the determined mission segment.

12. The vehicle of claim 11, wherein quality of service further comprises setting a frame rate.

13. The vehicle of claim 11, wherein quality of service further comprises setting a video resolution.

14. A method for adjusting video quality produced by image capture device on an aerial vehicle, the method comprising:
setting a first quality of service in a first mission segment based on at least one of the mission segment and an environmental condition;
detecting a change in at least one of the mission segment and the environmental condition; and
setting a second quality of service based on the detected change in at least one of the mission segment and the environmental condition.

15. The method of claim 14, wherein setting the first and second quality of services further comprises setting a frame rate.

16. The method of claim 15, wherein setting the first and second quality of services further comprises setting a video resolution.

17. The method of claim 14, wherein the mission segment further comprises at least two of a forward flight mode, a hover and stare mode, and an area surveillance mode.

18. The method of claim 14, wherein the environmental condition further comprises a weather condition.

19. The method of claim 14, wherein the environmental condition further comprises a light condition.
